(19) United States
(12) Patent Application Publication
(10) Pub. No.: US 2013/0176282 A1
(43) Pub. Date: Jul. 11, 2013

(54) TOUCH PANEL AND DISPLAY DEVICE PROVIDED WITH THE TOUCH PANEL

(71) Applicants: Hijiri Nakahara, Osaka-shi (JP); Yasuhiro Kohara, Osaka-shi (JP)

(72) Inventors: Hijiri Nakahara, Osaka-shi (JP); Yasuhiro Kohara, Osaka-shi (JP)

(73) Assignee: Sharp Kabushiki Kaisha, Osaka-shi, Osaka (JP)

(21) Appl. No.: 13/822,722

(22) PCT Filed: Sep. 29, 2011
(86) PCT No.: PCT/JP2011/072405

§ 371 Date: Mar. 13, 2013

(30) Foreign Application Priority Data
Oct. 8, 2010 (JP) 2010-228800

(51) Int. Cl. G06F 3/045

(52) U.S. Cl. CPC G06F 3/045
USPC 345/174

(57) ABSTRACT

Provided are a touch panel having a novel structure that is capable of allowing lines through which electric signals contributing to the detection of a touched position to have a lower sheet resistance and that is capable of suppressing corrosion of the lines; and a display device provided with the touch panel. A touch panel includes: a substrate (18); lines (36a to 36g) formed on the substrate (18) so that electric signals that contribute to detection of a touched position flow through the lines; terminal portions (42a to 42g) formed with respect to the lines (36a to 36g) so that the terminal portions are connected to an outer circuit; and covering films (20, 48a to 48g) that cover the terminal portions (42a to 42g), wherein the lines (36a to 36g) and the terminal portions (42a to 42g) are formed with metal films, and at least a part of the covering films (20, 48a to 48g) are conductive films (48a to 48g) that have higher corrosion resistance than the terminal portions (42a to 42g).

### TECHNICAL FIELD

The present invention relates to a touch panel, and a display device provided with the touch panel.

### BACKGROUND ART

Conventionally, a touch panel has been known as an input device for detecting a position of touch made by a finger, a pen, or the like. For example, a resistance film touch panel is disclosed in JP2004-70771A (Patent Document 1).

Incidentally, in a touch panel, a touched position is detected by utilizing an electric signal generated when the touch panel is touched. Therefore, it is necessary to make it unlikely that a delay would occur in transmission of an electric signal generated when the touch panel is touched, that is, an electric signal that contributes to the detection of a touched position.

However, in the touch panel disclosed in Patent Document 1, the line through which the electric signal contributing to the detection of a touched position passes is made of the same material as that of a transparent conductive film. As a result, the line has an increased sheet resistance, which tends to cause a delay to occur easily in the transmission of the electric signal.

JP2009-199249A (Patent Document 2) discloses a touch panel provided with lines made of metal films. However, in the touch panel disclosed in Patent Document 2, lines electrically connected with a flexible printed board are formed with metal films made of silver or the like, which is prone to corrosion. As a result, there is a risk of corrosion of the lines during the manufacture of the touch panel or during the application of current.

### DISCLOSURE OF INVENTION

It is an object of the present invention to provide a touch panel having a novel structure that allows lines through which electric signals contributing to the detection of a touched position flow to have a lower sheet resistance and that suppresses corrosion of the lines; and to provide a display device provided with the touch panel.

A touch panel of the present invention includes: a substrate; a line formed on the substrate so that an electric signal that contributes to detection of a touched position flows through the line; a terminal portion formed with respect to the line so that the terminal portion is connected to an outer circuit; and a covering film that covers the terminal portion, wherein the line and the terminal portion are formed with a metal film, and at least a part of the covering film is a conductive film that has higher corrosion resistance than that of the metal film most prone to corrosion in the terminal portion.

With the touch panel of the present invention, it is possible to decrease the sheet resistance of the lines through which electric signals contributing to the detection of a touched position, and to suppress the corrosion of the lines.

### BRIEF DESCRIPTION OF DRAWINGS

FIG. 1 is a cross-sectional view showing a schematic configuration of a display device as one embodiment of the present invention.

FIG. 2 is a plan view showing a touch panel as Embodiment 1 of the present invention.

FIG. 3 is a cross-sectional view taken along a line III-III in FIG. 2.

FIG. 4 is a cross-sectional view taken along a line IV-IV in FIG. 2.

FIG. 5 is an enlarged cross-sectional view showing principal members, the view being taken along a line V-V in FIG. 2.

FIG. 6A is a cross-sectional view showing a method for manufacturing the touch panel shown in FIG. 2, the view showing a state in which terminal portions are formed on a substrate.

FIG. 6B is a cross-sectional view showing the method for manufacturing the touch panel shown in FIG. 2, the view showing a state in which an insulating film is formed on the substrate.

FIG. 6C is a cross-sectional view showing the method for manufacturing the touch panel shown in FIG. 2, the view showing a state in which openings are formed in the insulating film.

FIG. 6D is a cross-sectional view showing the method for manufacturing the touch panel shown in FIG. 2, the view showing a state in which a transparent conductive film is formed on the insulating film.

FIG. 7 is an enlarged cross-sectional view showing principal members of a touch panel as Embodiment 2 of the present invention, the view being taken along a direction corresponding to the line V-V in FIG. 2.

### DESCRIPTION OF THE INVENTION

A touch panel according to one embodiment of the present invention includes: a substrate; a line formed on the substrate so that an electric signal that contributes to detection of a touched position flows through the line; a terminal portion formed with respect to the line so that the terminal portion is connected to an outer circuit; and a covering film that covers the terminal portion, wherein the line and the terminal portion are formed with at least one layer of a metal film, and at least a part of the covering film is a conductive film that has higher corrosion resistance than that of the metal film that is most prone to corrosion in the terminal portion (the first configuration relating to a touch panel).

In the first configuration relating to a touch panel, the line through which an electric signal contributing to the detection of a touched position flows and the terminal portion formed with respect to the line are formed with at least one layer of a metal film. This allows the line and the terminal portion formed with respect to the line to have a lower sheet resistance.

At least a part of the covering film covering the terminal portion is a conductive film that has higher corrosion resistance than that of the metal film that is most prone to corrosion in the terminal portion. This makes it possible to prevent corrosion of the terminal portion, while ensuring electric connection between the terminal portion and the outer circuit (e.g., a flexible printed board).

It should be noted that, if the terminal portion is formed with a single metal film, the metal film that is most prone to corrosion in the terminal portion is the aforementioned single metal film; and if the terminal portion is formed with a laminate metal film obtained by laminating a plurality of metal films, it is a metal film that is most prone to corrosion among the plurality of metal films.

The second configuration relating to a touch panel is the first configuration relating to a touch panel that is further modified so that the conductive film is a transparent conductive film. In this configuration, the conductive film can be formed by using the transparent conductive film used in the touch panel. As a result, the manufacture of the touch panel is facilitated.

The third configuration relating to a touch panel is the first or second configuration relating to a touch panel that is further modified so that the covering film includes an inorganic insulating film formed so as to cover the terminal portion, and the conductive film is in contact with the terminal portion via an opening formed through the inorganic insulating film. This configuration makes it possible to easily realize a configuration in which corrosion of the terminal portion is prevented, while electric connection of the terminal portion with the outer circuit is ensured.

The fourth configuration relating to a touch panel is the third configuration relating to a touch panel that is further modified so that the terminal portion has a width greater than a width of the line. This configuration makes it easy to provide an enough size of the opening. As a result, the formation of the opening is facilitated.

The fifth configuration relating to a touch panel is any one of the first to fourth configuration relating to the touch panel that is further modified so that the conductive film is formed on the same layer as the touch electrode used for detection of a touched position. This configuration makes it possible to form the touch electrode and the conductive film simultaneously.

The sixth configuration relating to a touch panel is the first or second configuration relating to a touch panel that is further modified so that an entirety of the covering film is the conductive film. This configuration makes it possible to simplify the touch panel manufacturing process.

The seventh configuration relating to a touch panel is any one of the first to sixth configurations relating to a touch panel that is further modified so that the terminal portion is formed with a laminate metal film obtained by laminating a plurality of metal films. In this configuration, a metal film that is prone to corrosion can be covered with a metal film that is not prone to corrosion. Consequently this makes it possible to prevent corrosion that occurs due to contact between a metal film prone to corrosion and a conductive film.

A display device according to one embodiment of the present invention includes the touch panel according to one embodiment of the present invention.

Hereinafter, more specific embodiments of the present invention are explained with reference to the drawings. The drawings referred to hereinafter show, in a simplified manner, only principal members illustration of which is needed for explanation of the present invention, among constituent members of an embodiment of the present invention, for convenience of explanation. Therefore, a touch panel and a display device according to the present invention may include arbitrary members that are not shown in the drawings that the present specification refers to. Further, the dimensions of the members shown in the drawings do not faithfully reflect actual dimensions of constituent members, dimensional ratios of the constituent members, etc.

### Embodiment 1

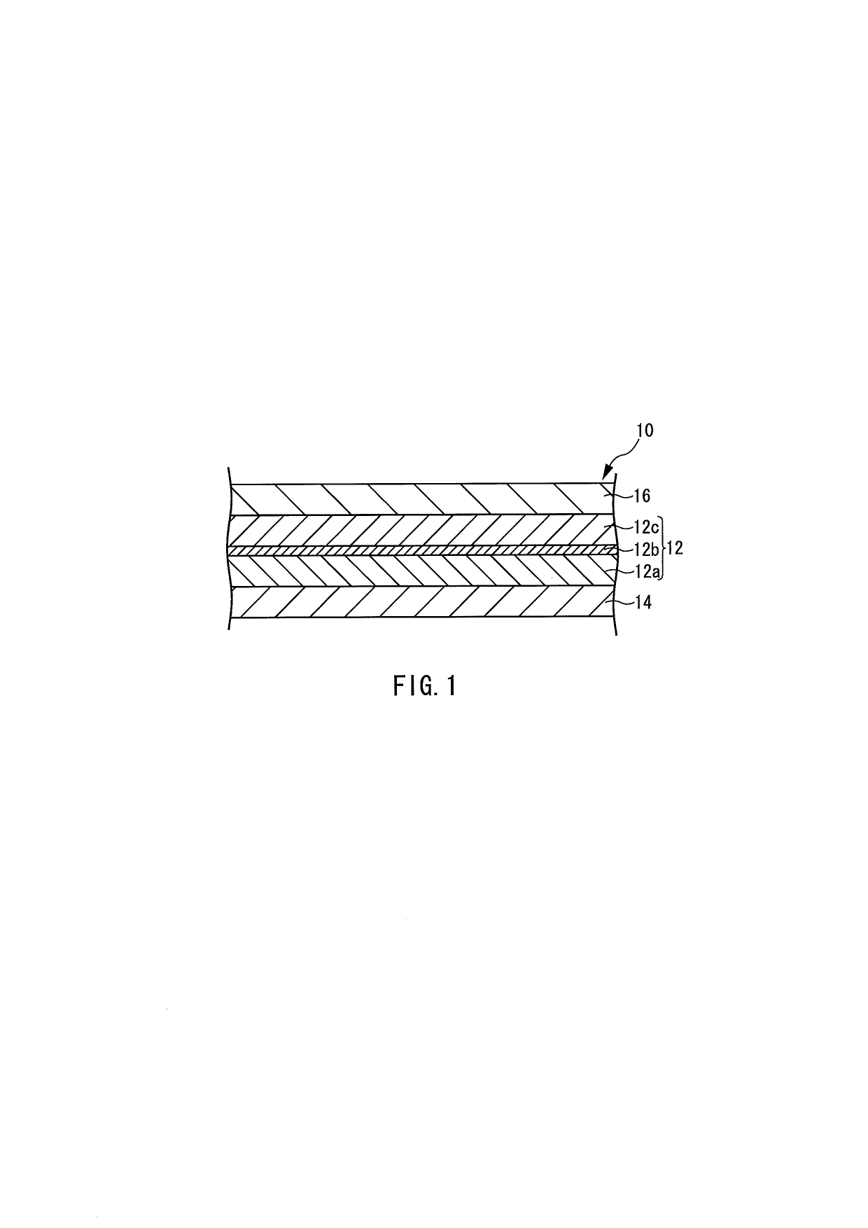

FIG. 1 shows a display device 10 as one embodiment of the present invention relating to a display device. The display device 10 includes a display panel 12, a backlight 14, and a touch panel 16 as Embodiment 1 of the present invention relating to a touch panel. In the display device 10, a display region of the display panel 12 is made visible to an observer via an input region of the touch panel 16. When the input region of the touch panel 16 is touched by a finger of an observer, a processing operation according to the touched position is made at the display panel 12.

The display panel 12 is a liquid crystal display panel. To briefly explain, the liquid crystal panel includes an active matrix substrate 12a on which a plurality of pixels are formed in matrix, a counter substrate 12c on which color filters are provided, and a liquid crystal layer 12c formed by injection to between the active matrix substrate 12a and the counter substrate 12c. The region where the plurality of pixels are formed in matrix is the display region of the display panel 12.

There is provided a backlight 14 on the display panel 12, on one side thereof in the thickness direction. As the backlight 14, any one of various types of backlights that have been known conventionally can be used.

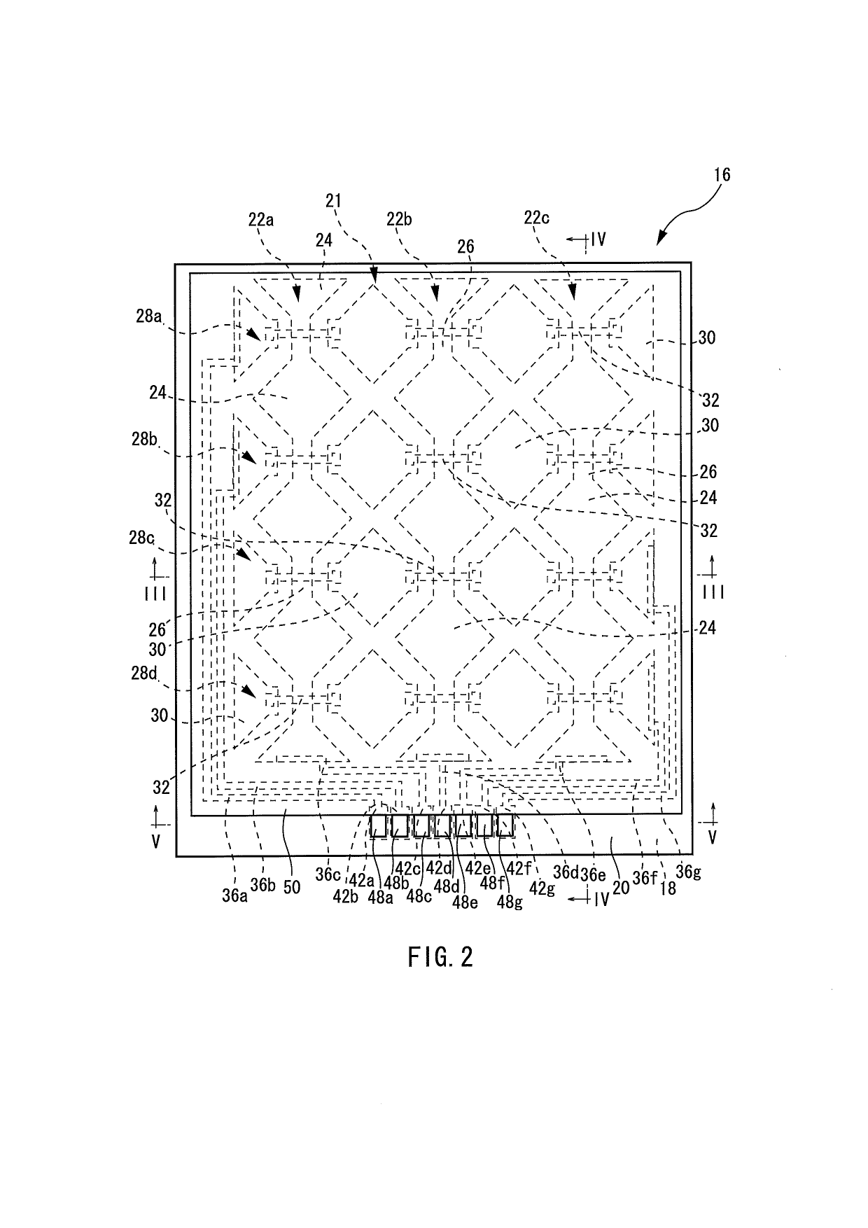

The touch panel 16 is provided on the other side of the display panel 12 in the thickness direction. The touch panel 16 includes a substrate 18, as shown in FIGS. 2 to 5. As the substrate 18, a glass substrate or the like, for example, can be used.

On the substrate 18, an insulating film 20 as an inorganic insulating film is formed. As the insulating film 20, a silicon oxide film or the like, for example, can be used.

On an upper surface of the substrate 18, touch electrodes 21 are formed. The region where the touch electrodes 21 are formed is the input region of the touch panel 16.

The touch electrodes 21 include a plurality of vertical electrodes 22a to 22c and a plurality of horizontal electrodes 28a to 28d. It should be noted that in the drawing, appropriate numbers of the vertical electrodes 22a to 22c and the horizontal electrodes 28a to 28c are shown, so that the configuration can be understood easily, but arbitrary numbers of these electrodes may be provided instead.

As the vertical electrodes 22a to 22c, indium tin oxide (ITO) films or the like, for example, can be used. It should be noted that in the present embodiment, ITO films are used as the vertical electrodes 22a to 22c.

The vertical electrodes 22a to 22c include a plurality of island-form electrode portions 24 and a plurality of bridge line portions 26. These island-form electrode portions 24 and bridge line portions 26 are formed so as to be alternate on the insulating film 20, and in this manner the vertical electrodes 22a to 22c extend along one edge of the substrate 18 (one edge extending in the vertical direction of FIG. 2). It should be noted that in the drawing, appropriate numbers of island-form electrode portions 24 and the bridge line portions 26 are shown, so that the configuration can be understood easily, but arbitrary numbers of the island-form electrode portions and bridge line portions may be provided instead.

The horizontal electrodes 28a to 28d include a plurality of island-form electrode portions 30 and a plurality of bridge line portions 32. It should be noted that in the drawing, appropriate numbers of island-form electrode portions 30 and the bridge line portions 32 are shown, so that the configuration can be understood easily, but arbitrary numbers of these island-form electrode portions and bridge line portions may be provided instead.

The island-form electrode portions 30 are formed on the insulating film 20. As the island-form electrode portions 30, indium tin oxide (ITO) films or the like, for example, can be used. It should be noted that in the present embodiment, the ITO films are used as the island-form electrode portions 30.

The bridge line portions 32 are formed on the substrate 18 and covered with the insulating film 20. As each bridge line portion 32, for example, a laminate metal film obtained by laminating a titanium film, an aluminum film, and a titanium nitride film in this order, or the like, can be used. It should be noted that in the present embodiment, a laminate metal film obtained by laminating a titanium film, an aluminum film, and a titanium nitride film in this order is used as the bridge line portion 32. It should be noted that the laminate structure of the bridge line portion 32 is not shown in the drawing.

These island-form electrode portions 30 and bridge line portions 32 are formed so as to be alternate as viewed in the plan view of the substrate 18, so that the horizontal electrodes 28a to 28d extend along one edge of the substrate 18 (one edge extending in the horizontal direction of FIG. 2). It should be noted that the electric connection between the island-form electrode portions 30 and the bridge line portions 32 is provided via contact holes 34 formed so as to pass through the insulating film 20 in the thickness direction.

On the substrate 18, a plurality of lines 36a to 36g are formed. It should be noted that an appropriate number of the lines 36a to 36g are shown in the drawing, so that the configuration can be understood easily, but an arbitrary number of the lines may be provided instead.

As each of the lines 36a to 36g, a metal film obtained by laminating a titanium film, an aluminum film, and a titanium nitride film in this order, or the like, can be used, for example. It should be noted that in the present embodiment, a laminate metal film obtained by laminating a titanium film, an aluminum film, and a titanium nitride film in this order is used as each of the lines 36a to 36b. It should be noted that the laminate structure of the lines 36a to 36g is not shown in the drawing.

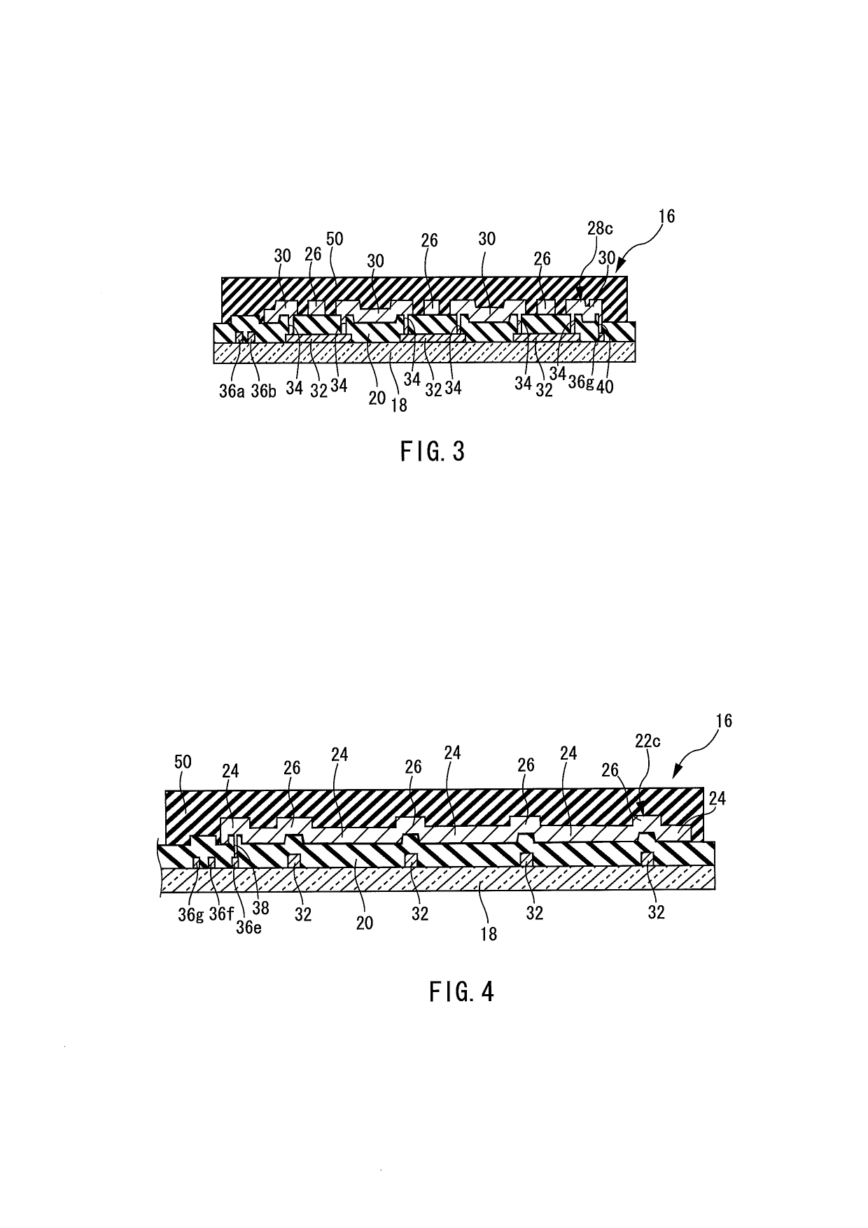

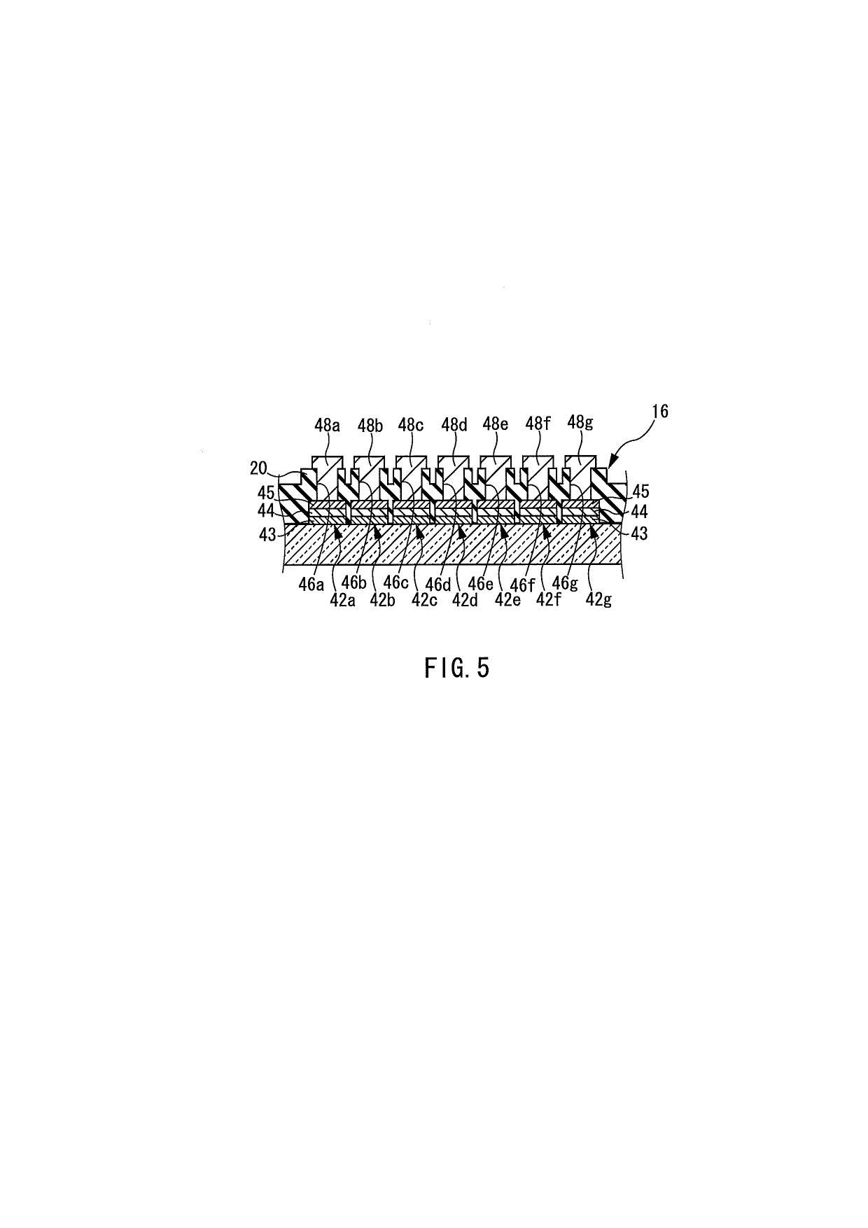

Among the lines 36a to 36g, the lines 36c to 36e are connected to the vertical electrodes 22a to 22c, respectively. The other lines 36a, 36b, 36f, and 36g are connected to the horizontal electrodes 28a to 28d, respectively. In other words, one line is connected to each of the plurality of the vertical electrodes and the horizontal electrodes. It should be noted that the electric connection between the lines 36c to 36e and the vertical electrodes 22a to 22c, respectively, and the electric connection between the lines 36a, 36b, 36f, and 36g and the horizontal electrodes 28a to 28d, respectively, are provided via contact holes 38 and 40 formed so as to pass through the insulating film 20 in the thickness direction (see FIGS. 3 and 4).

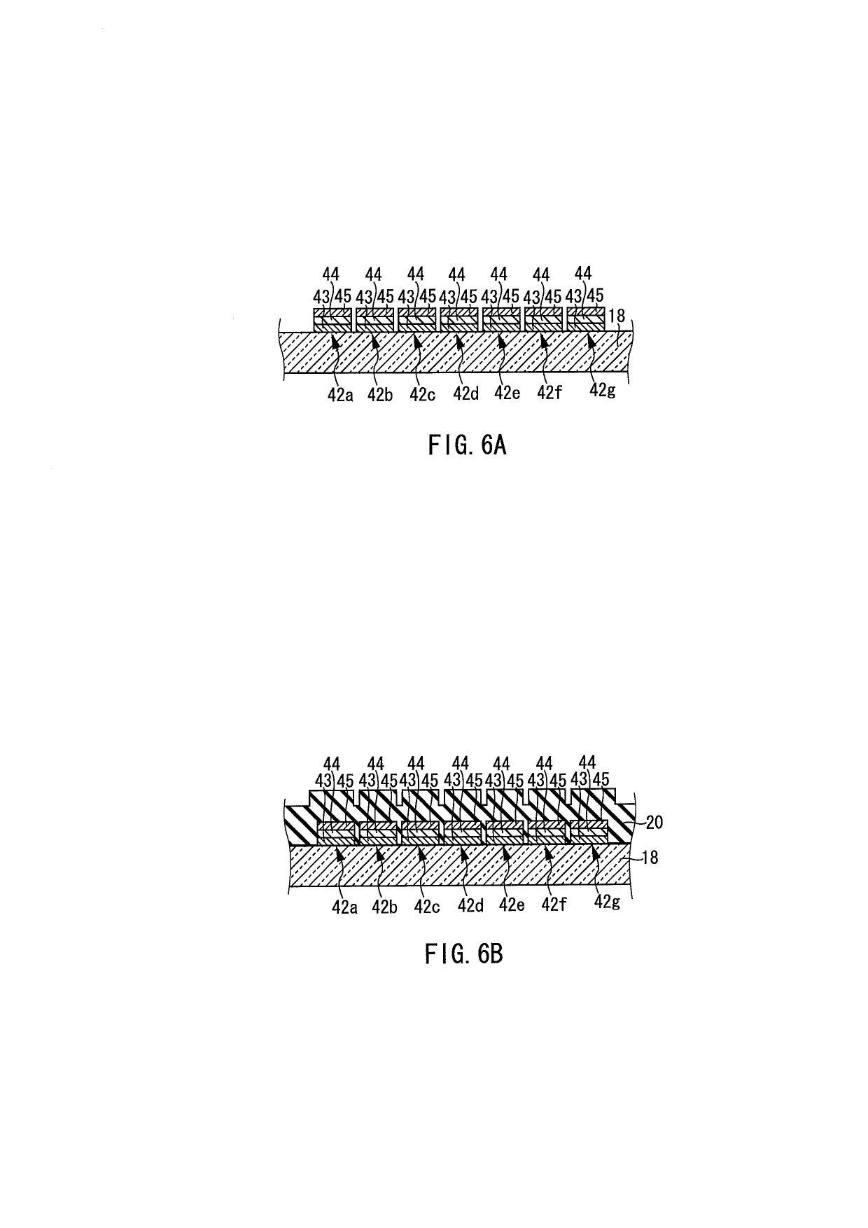

At extension ends of the lines 36a to 36g, terminal portions 42a to 42g are formed, respectively. As each of the terminal portions 42a to 42g, a metal film formed by laminating a titanium film, an aluminum film, and a titanium oxide film in this order, or the like, can be used, for example. It should be noted that, as shown in the enlarged view of FIG. 5, a laminate metal film obtained by laminating a titanium film 43, an aluminum film 44, and a titanium nitride film 45 in this order is used as each of the terminal portions 42a to 42g. The terminal portions 42a to 42g are formed in a width greater than the width of the lines 36a to 36g so as to extend in a direction in which the lines 36a to 36g extend, and each of which has a rectangular shape as viewed in the plan view of the substrate 18.

Top faces of the terminal portions 42a to 42g are covered with the insulating film 20. Particularly in the present embodiment, side faces of the terminal portions 42a to 42g are also covered with the insulating film 20.

In the insulating film 20, openings 46a to 46g that pass through the insulating film 20 in the thickness direction are formed at positions corresponding to the terminal portions 42a to 42g, respectively. This causes the top faces of the terminal portions 42a to 42g to be partially uncovered with the insulating film 22.

Each of the openings 46a to 46g has a rectangular shape smaller than each of the terminal portions 42a to 42g, as viewed in the plane view of the substrate 18. The openings 46a to 46g are formed at such positions that entireties of the same fall on the terminal portions 42a to 42g as viewed in the plan view of the substrate 18.

On the insulating film 20, transparent conductive films 48a to 48g as conductive films are formed at positions corresponding to the terminal portions 42a to 42g, respectively. As the transparent conductive films 48a to 48g, indium tin oxide (ITO) films or the like can be used, for example. It should be noted that in the present embodiment, ITO films are used as the transparent conductive films 48a to 48g. The transparent conductive films 48a to 48b are less prone to corrosion than the terminal portions 42a to 42g.

The transparent conductive films 48a to 48g enter the openings 46a to 46g. This allows the top faces of the terminal portions 42a to 42g to be partially covered with the transparent conductive films 48a to 48g, respectively. The other parts of the terminal portions 42a to 42g are covered with the insulating film 20.

As is clear from the above explanation, covering films that cover the terminals 42a to 42g are realized by the insulating film 20 and the transparent conductive films 48a to 48g in the present embodiment.

A protective film 50 is formed on the top face side of the substrate 18. As the protective film 50, a silicon oxide film or the like can be used, for example. The protective film 50 covers the vertical electrodes 22a to 22c and the island-form electrode portions 30 of the horizontal electrodes 28a to 28d. The protective film 50 does not cover the transparent conductive films 48a to 48g. The transparent conductive film 48a to 48g are exposed to outside.

Next, a method for manufacturing such a touch panel 16 is explained. It should be noted that the method for manufacturing the touch panel 16 is not limited to the manufacturing method described below.

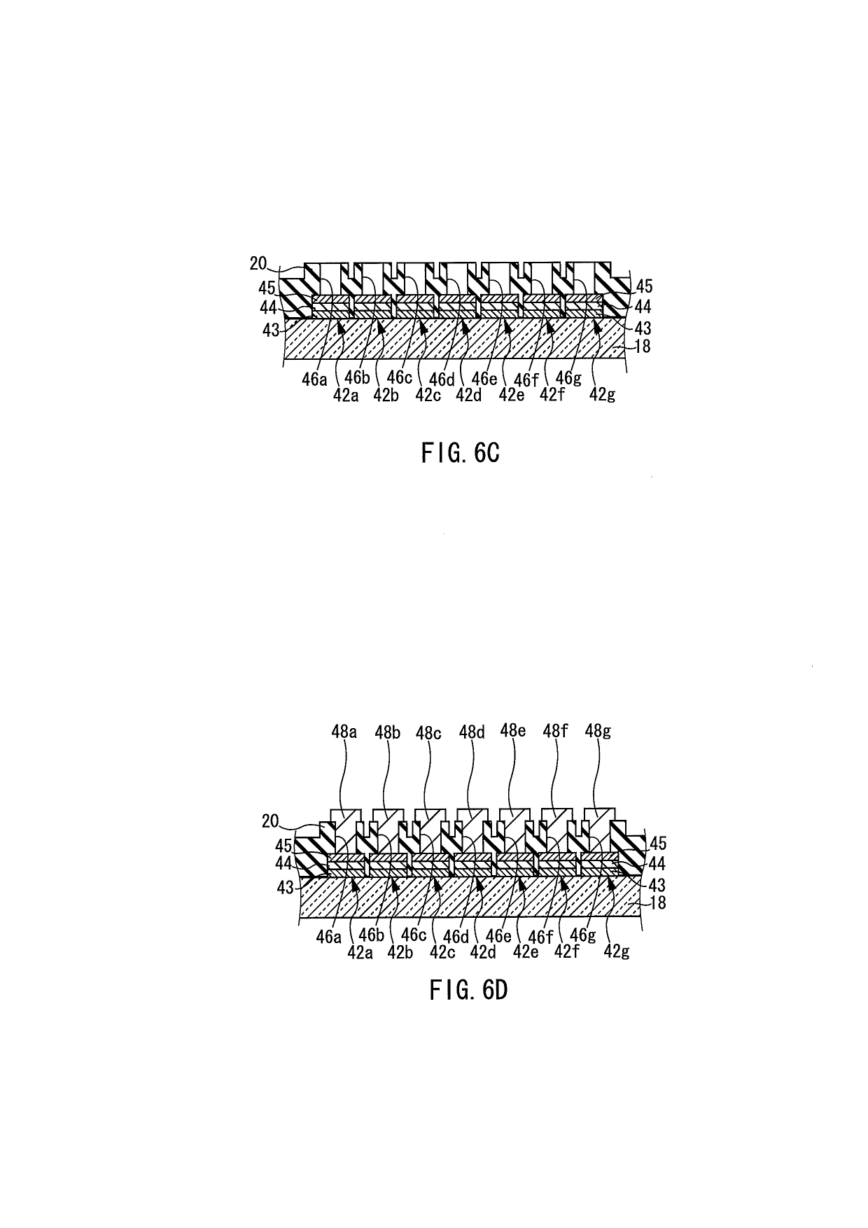

First, the bridge line portions 32 of the horizontal electrodes 28a to 28d, the lines 36a to 36g, and the terminal portions 42a to 42g are formed at predetermined positions on the substrate 18. More specifically, metal films that are to become the bridge line portions 32, the lines 36a to 36g, and the terminal portions 42a to 42g later are formed over an entire top face of the substrate 18 by sputtering. In the present embodiment, a titanium film, an aluminum film, and a titanium nitride film are laminated in this order. Thereafter, the metal films are patterned by photolithography. As a result, the bridge line portions 32 of the horizontal electrodes 28a to 28d, the lines 36a to 36g, and the terminal portions 42a to 42g are formed at predetermined positions on the substrate 18 (see FIG. 6A). It should be noted that FIG. 6A shows only the terminal portions 42a to 42g.

Subsequently, the insulating film 20 is formed on the top face side of the substrate 18 by CVD (chemical vapor deposition). This causes the entirety of the top face side of the substrate 18 to be covered with the insulating film 20. Consequently, the bridge line portions 32 of the horizontal electrodes 28a to 28d, the lines 36a to 36g, and the terminal portions 42a to 42g are covered with the insulating film 20 (see FIG. 6B). It should be noted that FIG. 6B shows only the state in which the terminal portions 42a to 42g are covered with the insulating film 20.

To the insulating film 20 thus formed, the contact holes 34, 38, and 40 and the openings 46a to 46g, which pass through the insulating film 20 in the thickness direction, are formed (see FIG. 6C). It should be noted that FIG. 6C shows only the openings 46a to 46g. The contact holes 34, 38, and 40 as well as the openings 46a to 46g are formed by photolithography.

Next, the vertical electrodes 22a to 22c, the island-form electrode portions 30 of the horizontal electrodes 28a to 28d, and the transparent conductive films 48a to 48g are formed at predetermined positions on the top face side of the substrate 18. More specifically, an ITO film that is to become the vertical electrodes 22a to 22c, the island-form electrode portions 30 of the horizontal electrodes 28a to 28d, and the transparent conductive films 48a to 48g later is formed over an entire top face of the substrate 18 by sputtering. Thereafter, this ITO film is patterned by photolithography. This causes the vertical electrodes 22a to 22c, the island-form electrode portions 30 of the horizontal electrodes 28a to 28d, and the transparent conductive films 48a to 48g are formed at predetermined positions on the substrate 18 (see FIG. 6D). It should be noted that FIG. 6D shows only the transparent conductive films 48a to 48g.

Subsequently, a silicon oxide film that is to become a protective film 50 later is formed on the top face side of the substrate 18 by CVD. Thereafter, this silicon oxide film is patterned by photolithography. This allows a desired touch panel 16 to be obtained, in which the protective film 50 is formed at a predetermined position on the substrate 18.

The touch panel 16 as described above is used in a state of being attached to the display panel 12. In the state where the touch panel 16 is attached to the display panel 12, the input region of the touch panel 16 and the display region of the display panel 12 coincide with each other.

To the touch panel 16, a flexible printed board as an outer circuit (not shown) is connected. More specifically, connection terminals provided in the flexible printed board are connected to the transparent conductive films 48a to 48g via an anisotropic conductive film (ACF) that is not shown in the drawing. This causes the flexible printed board and the terminal portions 42a to 42g to be connected electrically via the transparent conductive films 48a to 48g and an anisotropic conductive film (not shown).

The touch panel 16 has such a configuration that a touched position is detected by detecting a change in capacitances of electrostatic capacitors that are formed between a finger of an observer and some of the vertical electrodes 22a to 22c positioned close to the finger and some of the horizontal electrodes 28a to 28d positioned close to the finger when the finger touches a cover glass substrate (not shown) arranged so as to cover the protective film 50. In other words, the touch panel 16 of the present embodiment is a so-called projected capacitive touch panel.

In the display device having this touch panel 16, lines 36a to 36g formed with metal films are used. This allows the sheet resistance of the lines 36a to 36g to decrease. As a result, an electric signal generated when the touch panel 16 is touched is allowed to flow easily through the lines 36a to 36g, which makes it possible to prevent a delay in the transmission of the electric signals.

Particularly in the present embodiment, terminal portions 42a to 42g formed with laminate metal films each of which is formed by laminating a titanium film 43, an aluminum film 44, and a titanium nitride 45 in this order are used. This makes it possible to avoid galvanic corrosion due to contact between the aluminum film 44 and the transparent conductive films 48a to 48g.

The terminal portions 42a to 42g are covered with an insulating film 20 and transparent conductive films 48a to 48g. This makes it possible to prevent corrosion of the terminal portions 42a to 42g, while ensuring electric connection between the terminal portions 42a to 42g and the flexible printed board.

Particularly in the present embodiment, the side faces of the terminal portions 42a to 42g are entirely covered with the insulating film 20. This makes it possible to prevent corrosion of the terminal portions 42a to 42g more surely.

The terminal portions 42a to 42g have a width greater than the line width of the lines 36a to 36g. This allows each of the openings 46a to 46g to have an enough size. Consequently, this facilitates the formation of the openings 46a to 46g.

The vertical electrodes 22a to 22c, the island-form electrode portions 30 of the horizontal electrodes 28a to 28d, and the transparent conductive films 48a to 48g are formed through the same step of the manufacturing method. This makes it possible to form the transparent conductive films 48a to 48g as well while forming the vertical electrodes 22a to 22c, and the island-form electrode portions 30 of the horizontal electrodes 28a to 28d. Consequently this facilitates the manufacture of the touch panel 16.

The bridge line portions 32 of the horizontal electrodes 28a to 28g, the lines 36a to 36g, and the terminal portions 42a to 42g are formed through the same step of the manufacturing method. This makes it possible to form the terminal portions 42a to 42g as well while forming the bridge line portions 32 of the horizontal electrodes 28a to 28d and the lines 36a to 36g. Consequently this facilitates the manufacture of the touch panel 16.

The contact holes 34, 38, and 40, as well as the openings 46a to 46g are formed through the same step of the manufacturing method. This makes it possible to form the openings 46a to 46g as well while forming the contact holes 34, 38, and 40. Consequently this facilitates the manufacture of the touch panel 16.

### Embodiment 2

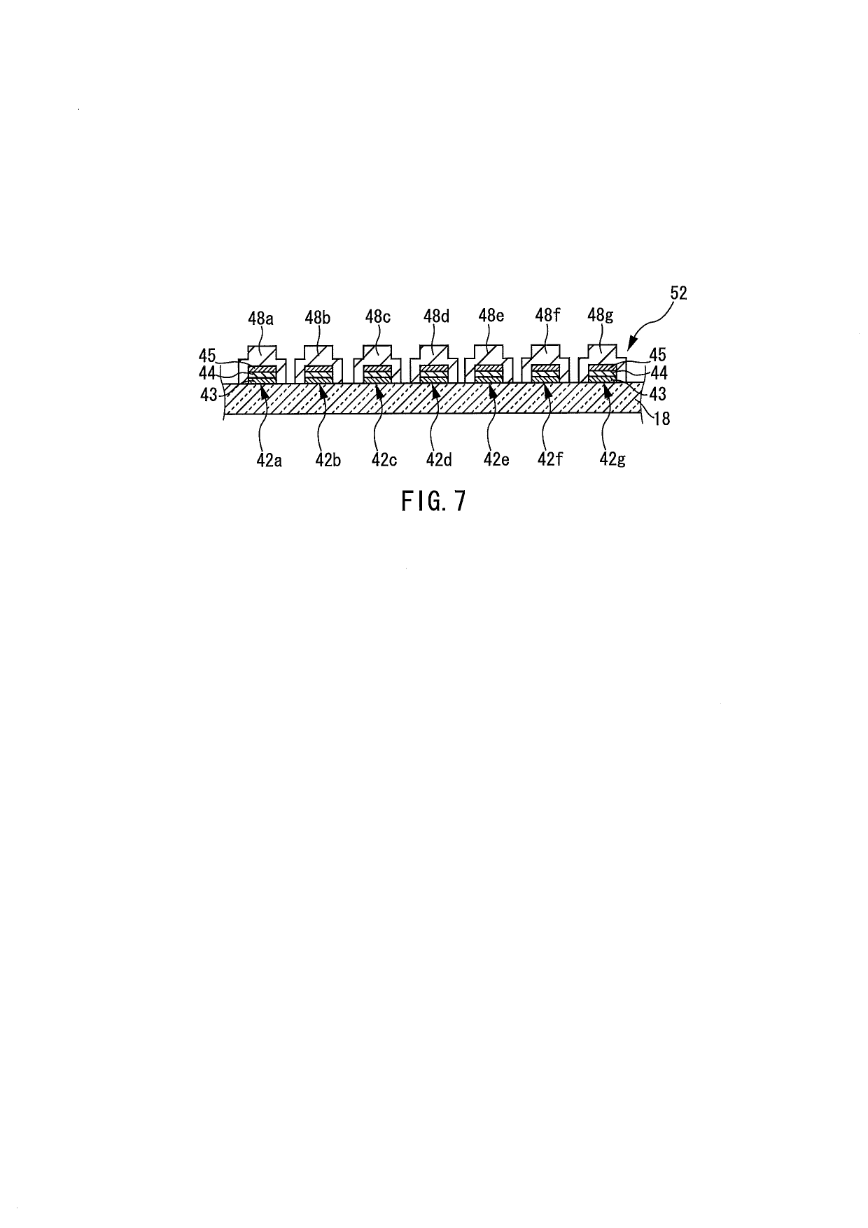

Next, a touch panel 52 as Embodiment 2 of the present invention is explained based on FIG. 7. It should be noted that members and portions having the same structures as those in Embodiment 1 in the following explanation are denoted by the same marks as those in Embodiment 1 in the drawings, and detailed descriptions of the same are omitted.

The touch panel 52 of the present embodiment is different from the touch panel 16 of Embodiment 1 regarding the covered state of the terminal portions 42a to 42g covered with a covering film. In the present embodiment, the terminal portions 42a to 42g are not covered with the insulating film 20. The terminal portions 42a to 42g are covered with the transparent conductive films 48a to 48g alone. As is clear from this, a covering film is realized by the transparent conductive films 48a to 48g in the present embodiment.

The transparent conductive films 48a to 48g cover, not only the top faces of the terminal portions 42a to 42g, but also the side faces of the terminal portions 42a to 42g. It should be noted that the transparent conductive films 48a to 48g may cover only the top faces of the terminal portions 42a to 42g.

Further, in the present embodiment, an organic insulating film made of an acrylic resin or the like is used as the insulating film 20. The use of an organic insulating film as the insulating film 20 makes it possible to increase a transmittance of the insulating film 20.

In such a touch panel 52, the organic insulating film, used as the insulating film 20, does not cover the terminal portions 42a to 42g. As a result, this makes it possible to prevent the anisotropic conductive film from peeling off when connection terminals of the flexible printed board as an outer circuit and the terminal portions 42a to 42g are connected electrically.

So far the embodiments of the present invention have been described in detail, but these are merely examples. The present invention is not limited at all by the above-described embodiments.

For example, Embodiments 1 and 2 are explained with reference to specific examples in which the present invention is applied to a projected capacitive touch panel. The touch panel to which the present invention can be applied, however, is not limited to the projected capacitive touch panel. The present invention can be applied to touch panels of various types, such as a surface capacitive touch panel, a resistive touch panel, an infrared touch panel, an ultrasonic touch panel, an electromagnetic touch panel, and the like.

In the above-described embodiments, a plasma display panel (PDP), an organic EL (electroluminescence) panel, an inorganic ET, panel, or the like can be used as the display panel.

Further, in Embodiments 1 and 2 described above, single-layer metal films can be used as the bridge line portions 32, the lines 36a to 36g, and the terminal portions 42a to 42g. As the single-layer metal film, an aluminum alloy film (Al alloy film), a silver alloy film (Ag alloy film), or the like, for example, can be used.

1. A touch panel comprising:
a substrate;
a line formed on the substrate so that an electric signal that contributes to detection of a touched position flows through the line;
a terminal portion formed with respect to the line so that the terminal portion is connected to an outer circuit; and
a covering film that covers the terminal portion,
wherein the line and the terminal portion are formed with at least one layer of a metal film, and
at least a part of the covering film is a conductive film that has higher corrosion resistance than that of the metal film that is most prone to corrosion in the terminal portion.

2. The touch panel according to claim 1, wherein the conductive film is a transparent conductive film.

3. The touch panel according to claim 1,
wherein the covering film includes an inorganic insulating film formed so as to cover the terminal portion, and
the conductive film is in contact with the terminal portion via an opening formed through the inorganic insulating film.

4. The touch panel according to claim 3, wherein the terminal portion has a width greater than a width of the line.

5. The touch panel according to claim 1, wherein the conductive film is formed on the same layer as the touch electrode used for detection of a touched position.

6. The touch panel according to claim 1, wherein an entirety of the covering film is the conductive film.

7. The touch panel according to claim 1, wherein the terminal portion is formed with a laminate metal film obtained by laminating a plurality of metal films.

8. A display device provided with the touch panel according to claim 1.
